(19) United States
(12) Patent Application Publication
(10) Pub. No.: US 2022/0261718 A1
(43) Pub. Date: Aug. 18, 2022

(54) INFORMATION PROCESSING DEVICE, VEHICLE, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventors: Atsushi OKUBO, Nisshin-shi (JP); Kento NITTA, Tokyo (JP); Takaaki KATO, Saitama-shi (JP); Daiki KANEICHI, Tokyo (JP); Minoru NAKADORI, Toyota-shi (JP)

(21) Appl. No.: 17/551,576

(22) Filed: Dec. 15, 2021

(30) Foreign Application Priority Data
Feb. 17, 2021 (JP) 2021-023648

(51) Int. Cl. G06Q 10/06

(52) U.S. Cl. CPC G06Q 10/06311; G06Q 2240/00

(57) ABSTRACT

An information processing device configured to communicate with a vehicle. The information processing device includes a controller configured to: determine a scheduled pickup date and time of a first vehicle to be parked in a parking lot; determine a scheduled pickup date and time of a second vehicle parked in the parking lot; and present a space adjacent to the second vehicle in a leaving direction of the second vehicle to the first vehicle as a parkable spot when the scheduled pickup date and time of the first vehicle is earlier than the scheduled pickup date and time of the second vehicle.

### CROSS-REFERENCE TO RELATED APPLICATION

This application claims priority to Japanese Patent Application No. 2021-023648 filed on Feb. 17, 2021, incorporated herein by reference in its entirety.

### BACKGROUND

### 1. Technical Field

The present disclosure relates to an information processing device, a vehicle, a non-transitory storage medium, and an information processing method.

### 2. Description of Related Art

A parking lot management system that identifies the size of a vehicle outside a parking lot with a sensor and guides the vehicle to a parking area according to the size of the vehicle in the parking lot with designated parking areas having different areas is an example of the related art (e.g., Japanese Unexamined Patent Application Publication No. 2003-296898 (JP 2003-296898 A)).

### SUMMARY

In the above related art, the parking areas are designated in advance. The number of vehicles that can be parked in the parking lot is therefore limited. Accordingly, there is room for improvement in how to use the space in the parking lot.

The present disclosure provides an information processing device, a vehicle, a non-transitory storage medium, and an information processing method that can effectively use the space in a parking lot.

An information processing device according to a first aspect of the present disclosure is configured to communicate with a vehicle. The information processing device comprising a controller configured to: determine a scheduled pickup date and time of a first vehicle to be parked in a parking lot; determine a scheduled pickup date and time of a second vehicle parked in the parking lot; and present a space adjacent to the second vehicle in a leaving direction of the second vehicle to the first vehicle as a parkable spot when the scheduled pickup date and time of the first vehicle is earlier than the scheduled pickup date and time of the second vehicle.

A vehicle according to a second aspect of the present disclosure may include the information processing device of the first aspect.

A non-transitory storage medium according to a third aspect of the present disclosure stores a program that is executable by a computer serving as an information processing device configured to communicate with a vehicle and that causes the computer to perform functions including: determining a scheduled pickup date and time of a first vehicle to be parked in a parking lot; determining a scheduled pickup date and time of a second vehicle parked in the parking lot; and presenting a space adjacent to the second vehicle in a leaving direction of the second vehicle to the first vehicle as a parkable spot when the computer determines that the scheduled pickup date and time of the first vehicle is earlier than the scheduled pickup date and time of the second vehicle.

An information processing method according to a fourth aspect of the present disclosure is an information processing method that is performed by an information processing device configured to communicate with a vehicle. The information processing method includes: determining a scheduled pickup date and time of a first vehicle to be parked in a parking lot; determining a scheduled pickup date and time of a second vehicle parked in the parking lot; and presenting a space adjacent to the second vehicle in a leaving direction of the second vehicle to the first vehicle as a parkable spot when the scheduled pickup date and time of the first vehicle is earlier than the scheduled pickup date and time of the second vehicle.

According to the information processing device, vehicle, non-transitory storage medium, and information processing method of the aspects of the present disclosure, the space in a parking lot can be effectively used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system of an embodiment;

FIG. 2 is a block diagram showing a configuration of an information processing device;

FIG. 3 is a block diagram showing a configuration of a vehicle;

FIG. 4 is a diagram showing a parking lot;

FIG. 5 is a diagram showing a scheduled pickup date and time of a vehicle;

FIG. 6 shows a data structure of a scheduled pickup date and time database (DB);

FIG. 7 is a diagram showing a presented parkable spot; and

FIG. 8 is a flowchart illustrating the operation of the information processing device.

### DETAILED DESCRIPTION OF EMBODIMENTS

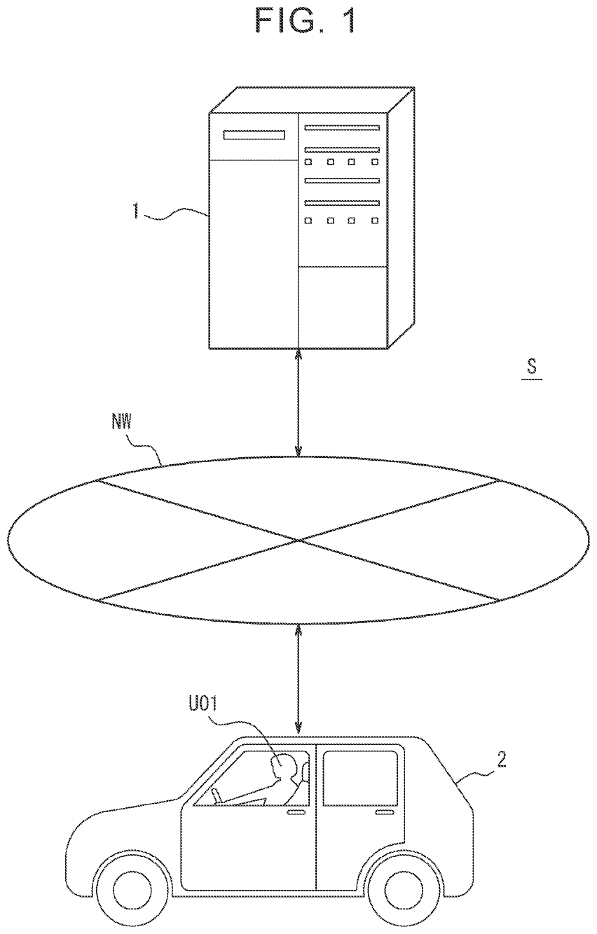

FIG. 1 is a schematic diagram of an information processing system S of an embodiment. The information processing system S includes an information processing device 1 and a first vehicle 2. The information processing device 1 and the first vehicle 2 can communicate with each other via a network NW. The network NW includes, for example, a mobile communication network or the Internet.

In FIG. 1, one information processing device 1 is shown for simplicity. However, the number of information processing devices 1 is not limited to one. For example, the processing that is performed by the information processing device 1 may be performed by a plurality of distributed information processing devices 1.

The information processing device 1 may be a server that assists a business operator in providing a service. The information processing device 1 may be installed in, for example, a facility exclusively for a business operator or a shared facility including a data center. In an alternative example, the information processing device 1 may be mounted on the first vehicle 2.

The first vehicle 2 includes, for example, any type of vehicle such as gasoline vehicle, diesel vehicle, HV, PHV, EV, or FCV. “HV” stands for Hybrid Vehicle. “PHV” stands for Plug-in Hybrid Vehicle. “EV” stands for Electric Vehicle. “FCV” stands for Fuel Cell Vehicle. The first vehicle 2 of the present embodiment is driven by a user U01 who is a driver. In an alternative example, driving of the first vehicle 2 may be automated at a desired level. The level of driving automation is, for example, any of Levels 1 to 5 defined by the SAE. “SAE” stands for Society of Automotive Engineers. The first vehicle 2 may be a MaaS-dedicated vehicle. “MaaS” stands for Mobility as a Service.

An overview of the processing that is performed by the information processing device 1 of the present embodiment will be described. The information processing device 1 determines a scheduled pickup date and time of the first vehicle 2 that is going to be parked in a parking lot and a scheduled pickup date and time of a second vehicle parked in the parking lot. Pickup means that a vehicle leaves the parking lot or a predetermined area in the parking lot. When the information processing device 1 determines that the scheduled pickup date and time of the first vehicle 2 is earlier than the scheduled pickup date and time of the second vehicle, the information processing device 1 presents a space on the leaving direction side of the second vehicle (a space adjacent to the second vehicle in the leaving direction) to the first vehicle 2 as a parkable spot. That is, the information processing device 1 presents the space on the leaving direction side of the second vehicle whose scheduled pickup date and time is later than the scheduled pickup date and time of the first vehicle 2 to the first vehicle 2 as a parkable spot. With this configuration, the information processing device 1 can use the space on the leaving direction side of the parked second vehicle as a parking space while reducing the possibility of obstructing the second vehicle when the second vehicle leaves its parking space. The information processing device 1 can thus effectively use the space in the parking lot.

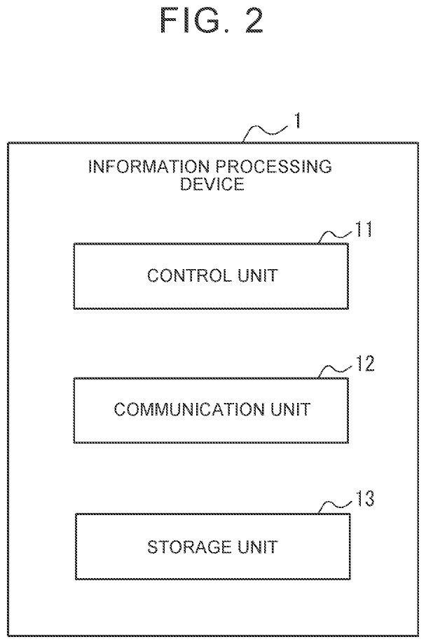

The internal configuration of the information processing device 1 will be described in detail with reference to FIG. 2.

The information processing device 1 includes a control unit 11, a communication unit 12, and a storage unit 13. Components of the information processing device 1 are connected to each other via, for example, a dedicated line so that they can communicate with each other.

The control unit (controller) 11 includes, for example, one or more general-purpose processors including a central processing unit (CPU) or a micro processing unit (MPU). The control unit 11 may include one or more dedicated processors specialized for specific processing. The control unit 11 may include one or more dedicated circuits instead of including the processor(s). The dedicated circuit may be, for example, a field-programmable gate array (FPGA) or an application-specific integrated circuit (ASIC). The control unit 11 may include an electronic control unit (ECU).

The communication unit 12 includes a communication module compatible with one or more wired or wireless local area network (LAN) standards for connecting to a network. The communication unit 12 may include a module compatible with one or more mobile communication standards including Long Term Evolution (LTE), 4th Generation (4G), or 5th Generation (5G). The communication unit 12 may include a communication module etc. compatible with one or more short-range communication standards or specifications including Bluetooth (registered trademark), AirDrop (registered trademark), Infrared Data Association (IrDA), ZigBee (registered trademark), FeliCa (registered trademark), or Radio-Frequency Identification (RFID). The communication unit 12 sends and receives desired information via the network NW.

For example, the storage unit 13 includes, but is not limited to, a semiconductor memory, a magnetic memory, an optical memory, or a combination of at least two of these memories. The semiconductor memory is, for example, a random access memory (RAM) or a read-only memory (ROM). The RAM is, for example, a static RAM (SRAM) or a dynamic RAM (DRAM). The ROM is, for example, an electrically erasable programmable ROM (EEPROM). The storage unit 13 may function as, for example, a main storage device, an auxiliary storage device, or a cache memory. The storage unit 13 may store information as a result of analysis or processing by the control unit 11. The storage unit 13 may store various kinds of information etc. regarding the operation or control of the information processing device 1. The storage unit 13 may store a system program, an application program, embedded software, etc. The storage unit 13 includes a scheduled pickup date and time database (DB).

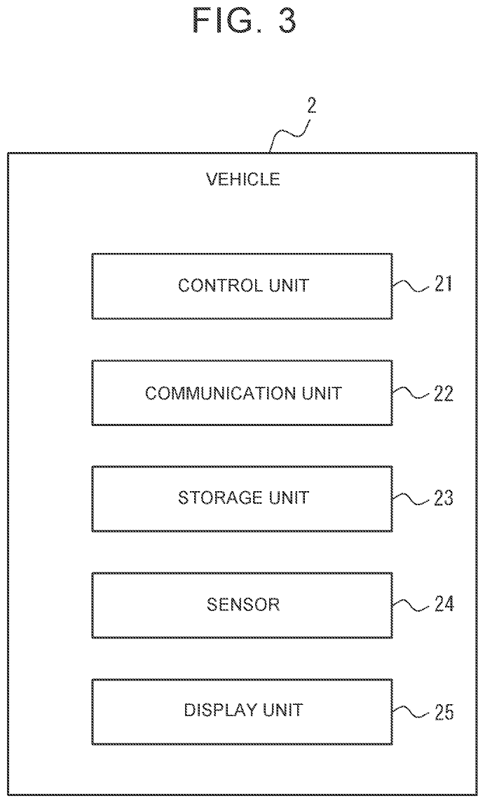

The internal configuration of the first vehicle 2 will be described in detail with reference to FIG. 3.

The first vehicle 2 includes a control unit 21, a communication unit 22, a storage unit 23, a sensor 24, and a display unit 25. Components of the first vehicle 2 are connected to each other via, for example, a dedicated line so that they can communicate with each other.

The hardware configurations of the control unit 21, the communication unit 22, and the storage unit 23 may be the same as the hardware configurations of the control unit 11, the communication unit 12, and the storage unit 13 of the information processing device 1. Description of these units will therefore be omitted.

The sensor 24 may be at least one of the following sensors: an image sensor, an acceleration sensor, and a position information sensor. The sensor 24 detects the position of the first vehicle 2. The sensor 24 can also detect the traveling direction and attitude of the first vehicle 2. The sensor 24 can output the detected information to the control unit 21 as sensor information.

The position information sensor as the sensor 24 includes at least one GNSS receiver. “GNSS” stands for Global Navigation Satellite System. GNSS includes, for example, at least one of the following: GPS, QZSS, BeiDou, GLONASS, and Galileo. “GPS” stands for Global Positioning System. “QZSS” stands for Quasi-Zenith Satellite System. QZSS satellites are called quasi-zenith satellites. “GLONASS” stands for Global Navigation Satellite System. The sensor 24 measures the position of the first vehicle 2. The control unit 21 acquires the result of the measurement by the sensor 24 as position information of the first vehicle 2. The “position information” is information that can identify the position of the first vehicle 2, and includes, for example, coordinates.

In an example, the display unit 25 is a head-up display (HUD) mounted on the first vehicle 2. The display unit 25 projects a virtual image showing a parkable spot presented by the information processing device 1 in real space. In an alternative example, the display unit 25 may be augmented reality (AR) glasses that are worn and operated by the driver of the first vehicle 2. In another alternative example, the display unit 25 is a display. The display unit 25 displays information identifying a parkable spot presented by the information processing device 1. The display is, for example, an LCD or an organic EL display. “LCD” stands for liquid crystal display. “EL” stands for electroluminescence. The display unit 25 may be connected to the first vehicle 2 as an external output device instead of being provided in the first vehicle 2. In this case, any connection method such as universal serial bus (USB), High-Definition Multimedia Interface (HDMI) (registered trademark), or Bluetooth (registered trademark) may be used.

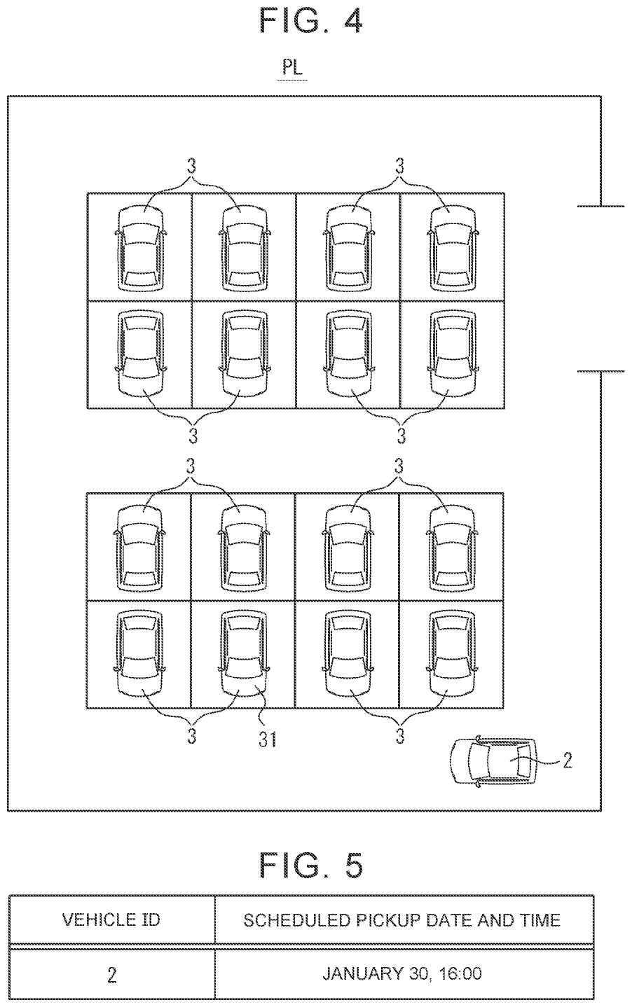

Hereinafter, the processing that is performed by the information processing system S of the present embodiment will be described in detail. A situation in which the first vehicle 2 is going to be parked in a parking lot PL as shown in FIG. 4 will be described as an example. One or more second vehicles 3 are parked in the parking lot PL. Although parking slot markings are shown by continuous lines in FIG. 4, there may actually not be parking slot markings. The information processing device 1 can communicate with the one or more second vehicles 3. The hardware configuration of the second vehicle 3 may be the same as the hardware configuration of the first vehicle 2.

The information processing device 1 receives a parking request from the first vehicle 2.

The information processing device 1 may additionally determine whether the occupancy rate of the parking lot PL is higher than a reference value. The occupancy rate is the ratio of the number of parking slots occupied by vehicles to the total number of parking slots in the parking lot PL. The reference value can be set to any numerical value. For example, the reference value is 95%. In an example, the information processing device 1 may perform a presentation process only when the occupancy rate of the parking lot PL is higher than the reference value. The presentation process will be described later.

The information processing device 1 determines the scheduled pickup date and time of the first vehicle 2. The scheduled pickup date and time is either or both of the date and time the first vehicle 2 leaves its parking spot. The time may be in hours, minutes, or seconds.

For example, the information processing device 1 determines the scheduled pickup date and time of the first vehicle 2 by acquiring information on the scheduled pickup date and time from the first vehicle 2. The information processing device 1 links the acquired information to a vehicle ID and stores them in the storage unit 13. The vehicle ID is vehicle identification information. An example in which the scheduled pickup date and time of the first vehicle 2 is January 30 at 16:00 as shown in FIG. 5 will be described below. In an alternative example, the information processing device 1 may determine the scheduled pickup date and time of the first vehicle 2 by referring to the schedule of the user U01 of the first vehicle 2.

The information processing device 1 extracts the one or more second vehicles 3 parked in the parking lot PL. The information processing device 1 can communicate with the one or more second vehicles 3. For example, the information processing device 1 determines from the position information of the second vehicle 3 that the second vehicle 3 is parked in the parking lot PL.

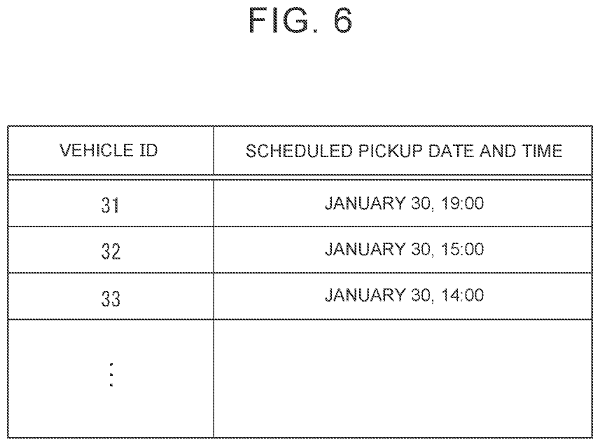

The information processing device 1 determines the scheduled pickup date and time of each of the one or more second vehicles 3. As shown in FIG. 6, the scheduled pickup date and time of each of the one or more second vehicles 3 of the present embodiment is linked to a vehicle ID and stored in the scheduled pickup date and time DB. The vehicle ID is vehicle identification information. An example in which the scheduled pickup dates and times of second vehicles 31, 32, and 33 are January 30 at 19:00, 15:00, and 14:00, respectively, as shown in FIG. 6 will be described. In an alternative example, the information processing device 1 may determine the scheduled pickup date and time of each of the one or more second vehicles 3 by referring to the schedules of the users of the one or more second vehicles 3.

The information processing device 1 compares the scheduled pickup date and time of the first vehicle 2 with the scheduled pickup date and time of each of the one or more second vehicles 3. Specifically, the information processing device 1 determines whether the scheduled pickup date and time of the first vehicle 2 is earlier than the scheduled pickup date and time of the second vehicle 3. As shown in FIG. 6, the scheduled pickup date and time of the second vehicle 31 is January 30 at 19:00. The scheduled pickup date and time of the first vehicle 2 is therefore earlier than the scheduled pickup date and time of the second vehicle 31. That is, even when the first vehicle 2 is parked in a space on the leaving direction side of the second vehicle 31, it is highly probable that the first vehicle 2 will not obstruct the second vehicle 31 when the second vehicle 31 leaves its parking space.

The leaving direction is the direction in which the second vehicle 31 moves when it starts moving to leave its parking space. That is, the space on the leaving direction side of the second vehicle 31 is the space in front of the second vehicle 31 when the second vehicle 31 is parked backward as shown in FIG. 4. The space on the leaving direction side of the second vehicle 31 is the space behind the second vehicle 31 when the second vehicle 31 is parked forward.

The information processing device 1 determines that the space on the leaving direction side of the second vehicle 31 is a parkable space.

The information processing device 1 may additionally ask the user of the second vehicle 31 for permission for the first vehicle 2 to be parked in the space on the leaving direction side of the second vehicle 31. For example, the information processing device 1 may ask a mobile terminal of the user of the second vehicle 31 for permission for parking of the first vehicle 2 in this space. In an example, the information processing device 1 may perform the presentation process only when the permission is obtained in advance from the user of the second vehicle 31.

The information processing device 1 may notify the first vehicle 2 that the information processing device 1 is asking the user of the second vehicle 31 for permission for the first vehicle 2 to be parked in the space on the leaving direction side of the second vehicle 31.

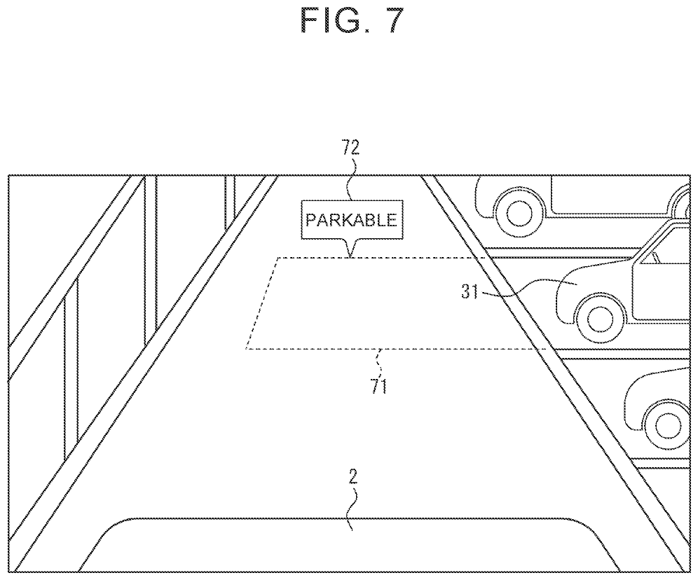

The information processing device 1 presents the space on the leaving direction side of the second vehicle 31 to the first vehicle 2 as a parkable spot. That is, the information processing device 1 performs the presentation process. Specifically, the information processing device 1 notifies the first vehicle 2 that the space on the leaving direction side of the second vehicle 31 is a parkable spot. As shown in FIG. 7, when the first vehicle 2 receives the presentation from the information processing device 1, the display unit 25 of the first vehicle 2 displays a space 71 on the leaving direction side of the second vehicle 31 as a parkable spot. For example, the display unit 25 may project virtual parking spot markings so that the space 71 on the leaving direction side of the second vehicle 31 can be visually recognized. The display unit 25 may project a virtual note 72 indicating that the space 71 on the leaving direction side of the second vehicle 31 is a parkable spot. In an additional example or an alternative example, the display unit 25 may display to the user U01 a screen indicating that the space 71 on the leaving direction side of the second vehicle 31 is a parkable spot.

The information processing device 1 may additionally notify the first vehicle 2 that there is a possibility that the first vehicle 2 may be moved to another location due to a change in scheduled pickup date and time of the second vehicle 31. The content of the notification is displayed on the display unit 25 of the first vehicle 2 and is recognized by the user of the first vehicle 2. The user of the first vehicle 2 can operate the first vehicle 2 to give consent to the possible movement of the first vehicle 2. The information processing device 1 may perform the above presentation process only when prior consent to the possible movement of the first vehicle 2 is obtained from the first vehicle 2. The information processing device 1 may ask the first vehicle 2 to leave an electronic or physical key of the first vehicle 2 to a manager of the parking lot PL. A desired expiration date can be set for the electronic key.

In an alternative example, when the information processing device 1 determines that the scheduled pickup date and time of the first vehicle 2 is earlier than the scheduled pickup dates and times of a plurality of second vehicles 3, the information processing device 1 may present the space on the leaving direction side of the second vehicle 3 whose scheduled pickup date and time are the least probable to be moved forward out of the second vehicles 3 to the first vehicle 2 as a parkable spot. For example, the information processing device 1 may determine that there is a low probability that the scheduled pickup date and time of the second vehicle 3 will be moved forward when all the family members using the second vehicle 3 are traveling abroad. The information processing device 1 may determine that there is a high probability that the scheduled pickup date and time of the second vehicle 3 will be moved forward when some of the family members using the second vehicle 3 are on a business trip overseas and others are staying near the parking lot PL. The information processing device 1 may determine the probability that the scheduled pickup date and time of the second vehicle 3 will be moved forward based on the past history of the user of the second vehicle 3 moving forward the scheduled pickup date and time.

When the information processing device 1 detects a change in scheduled pickup date and time of the second vehicle 31 to a date and time earlier than the scheduled pickup date and time of the first vehicle 2, the information processing device 1 moves the first vehicle 2 to another location at a date and time earlier than the scheduled pickup date and time of the second vehicle 31. For example, the information processing device 1 moves the first vehicle 2 by operating a desired robot such as automated valet parking (AVP) robot. The first vehicle 2 may be moved to a space on the leaving direction side of the second vehicle 3 linked to a scheduled pickup date and time later than the scheduled pickup date and time of the first vehicle 2.

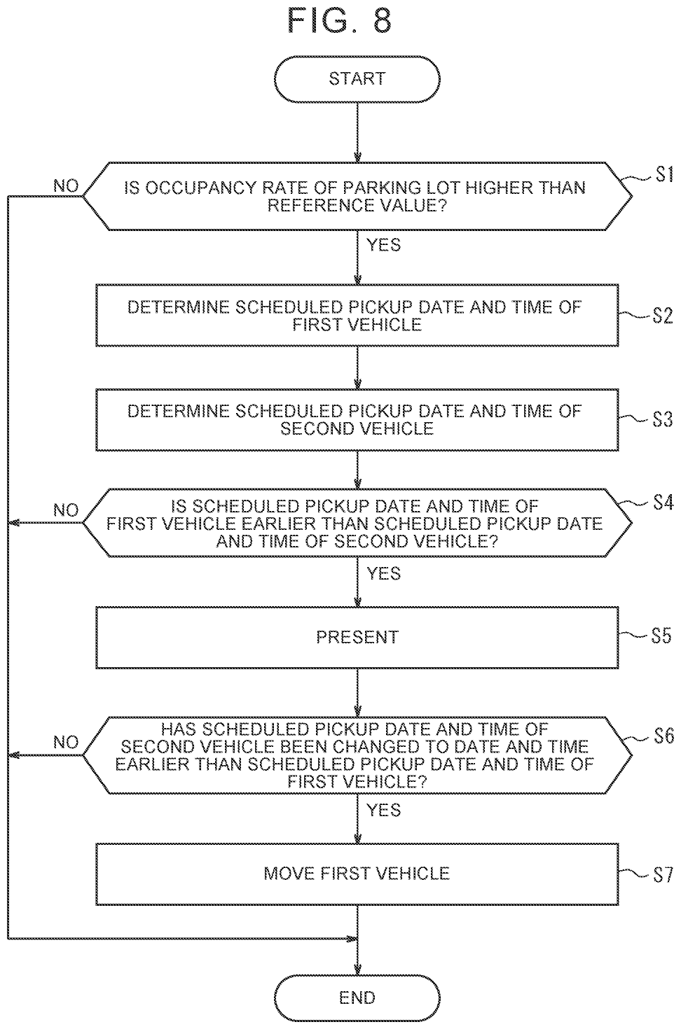

An information processing method that is performed by the information processing device 1 of the present embodiment will be described with reference to FIG. 8.

When the information processing device 1 receives a parking request from, for example, the first vehicle 2, the information processing device 1 determines whether the occupancy rate of the parking lot PL is higher than the reference value in step S1.

When No in step S1, the information processing device 1 ends the flow.

When Yes in step S1, the information processing device 1 determines the scheduled pickup date and time of the first vehicle 2 in step S2. In step S3, the information processing device 1 determines the scheduled pickup date and time of the second vehicle 3. The order of steps S2 and S3 may be reversed.

In step S4, the information processing device 1 determines whether the scheduled pickup date and time of the first vehicle 2 is earlier than the scheduled pickup date and time of the second vehicle 3.

When No in step S4, the information processing device 1 ends the flow.

When Yes in step S4, the information processing device 1 presents the space on the leaving direction side of the second vehicle 3 to the first vehicle 2 as a parkable spot in step S5. In an alternative example, when the information processing device 1 determines that the scheduled pickup date and time of the first vehicle 2 is earlier than the scheduled pickup dates and times of a plurality of second vehicles 3, the information processing device 1 may present in step S5 the space on the leaving direction side of the second vehicle 3 whose scheduled pickup date and time are the least probable to be moved forward out of the second vehicles 3 to the first vehicle 2 as a parkable spot. In another alternative example, the information processing device 1 may ask the user of the second vehicle 3 for permission for the first vehicle 2 to be parked in the space on the leaving direction side of the second vehicle 3, and may perform the presentation process of step S5 only when permission for parking of the first vehicle 2 in this space is given by the user of the second vehicle 3. The information processing device 1 may notify the first vehicle 2 that there is a possibility that the first vehicle 2 may be moved to another location if there is a change in scheduled pickup date and time of the second vehicle 3, and may perform the presentation process of step S5 only when consent to the possible movement of the first vehicle 2 is obtained from the first vehicle 2.

In step S6, the information processing device 1 determines whether the scheduled pickup date and time of the second vehicle 3 has been changed to a date and time earlier than the scheduled pickup date and time of the first vehicle 2.

When No in step S6, the information processing device 1 ends the flow.

When Yes in step S6, the information processing device 1 moves the first vehicle 2 to another location at a date and time earlier than the scheduled pickup date and time of the second vehicle 3 in step S7.

As described above, according to the present embodiment, the control unit 11 of the information processing device 1 determines the scheduled pickup date and time of the first vehicle 2 that is going to be parked in the parking lot and the scheduled pickup date and time of the second vehicle 3 parked in the parking lot. When the control unit 11 determines that the scheduled pickup date and time of the first vehicle 2 is earlier than the scheduled pickup date and time of the second vehicle 3, the control unit 11 presents the space on the leaving direction side of the second vehicle 3 to the first vehicle 2 as a parkable spot. With this configuration, the information processing device 1 can use the space on the leaving direction side of the parked second vehicle 3 as a parking space while reducing the risk of obstructing the second vehicle 3 when the second vehicle 3 leaves its parking space. The information processing device 1 can thus effectively use the space in the parking lot.

According to the present embodiment, when the scheduled pickup date and time of the second vehicle 3 is changed to a date and time earlier than the scheduled pickup date and time of the first vehicle 2 after the first vehicle 2 is parked in the space on the leaving direction side of the second vehicle 3, the control unit 11 moves the first vehicle 2 to another location at a date and time earlier than the scheduled pickup date and time of the second vehicle 3. With this configuration, the information processing device 1 can still allow the second vehicle 3 to leave its parking space even when the scheduled pickup date and time of the second vehicle 3 is moved forward.

In an alternative example, when the control unit 11 determines that the scheduled pickup date and time of the first vehicle 2 is earlier than the scheduled pickup dates and times of a plurality of second vehicles 3, the control unit 11 presents as a parkable spot the space on the leaving direction side of the second vehicle 3 whose scheduled pickup date and time are the least probable to be moved forward out of the second vehicles 3. With this configuration, the information processing device 1 guides the first vehicle 2 to the space on the leaving direction side of the second vehicle 3 whose scheduled pickup date and time are the least probable to be moved forward, the probability that the first vehicle 2 will have to be moved is reduced.

According to the present embodiment, when the control unit 11 determines that the scheduled pickup date and time of the first vehicle 2 is earlier than the scheduled pickup date and time of the second vehicle 3, the control unit 11 asks the user of the second vehicle 3 for permission for the first vehicle 2 to be parked in the space on the leaving direction side of the second vehicle 3 before the control unit 11 presents the space on the leaving direction side of the second vehicle 3 as a parkable spot. According to the present embodiment, the control unit 11 notifies the first vehicle 2 that the control unit 11 is asking the user of the second vehicle 3 for the permission. According to the present embodiment, when the control unit 11 determines that the scheduled pickup date and time of the first vehicle 2 is earlier than the scheduled pickup date and time of the second vehicle 3, the control unit 11 notifies the first vehicle 2 that there is a possibility that the first vehicle 2 may be moved to another location due to a change in scheduled pickup date and time of the second vehicle 3. With these configurations, since the information processing device 1 has the first vehicle 2 parked with the consent of the user of the second vehicle 3, unnecessary trouble between the users can be avoided.

According to the present embodiment, when the occupancy rate of the parking lot is higher than the reference value, the control unit 11 presents the space on the leaving direction side of the second vehicle 3 as a parkable spot. With this configuration, the information processing device 1 allows vehicles to be parked very close together like “sardines in a can” only when there are only a small number of available spaces left in the parking lot. The information processing device 1 can thus effectively use the space in the parking lot.

Although the present disclosure is described based on the drawings and embodiment, it should be noted that those skilled in the art could make various modifications and alterations based on the present disclosure. Other changes are also possible without departing from the spirit and scope of the present disclosure. For example, the functions etc. included in each means or each step may be rearranged so as not to be logically inconsistent, and a plurality of means or steps may be combined into one or a single means or step may be divided into two or more.

For example, in the above embodiment, a program that executes all or a part of the functions or processes of the information processing device 1 can be recorded on a computer-readable recording medium. The computer-readable recording medium includes a non-transitory computer-readable medium and is, for example, a magnetic recording device, an optical disc, an magneto-optic recording medium, or a semiconductor memory. The program is distributed by, for example, selling, transferring, or renting a portable recording medium having the program recorded thereon, such as digital versatile disc (DVD) or compact disc read-only memory (CD-ROM). The program may be distributed by storing the program in a storage of a desired server and transferring the program from the desired server to other computers. The program may be provided as a program product. The present disclosure may be implemented as a program that is executable by a processor.

For example, a computer first stores in a main storage device the program recorded on the portable recording medium or the program transferred from the server. The computer then causes a processor to read the program stored in the main storage device and causes the processor to perform processing according to the read program. The computer may read the program directly from the portable recording medium and perform processing according to the program. The computer may perform processing according to the received program every time the program is transferred from the server to the computer. The program may not be transferred from the server to the computer, and processing may be performed by what is called an ASP service that implements the functions only by execution instructions and acquisition of results. “ASP” stands for application service provider. The program includes information that is provided for processing by an electronic computer and that is equivalent to the program. For example, data that is not a direct command to the computer but has the property of defining the processing of the computer is the “information equivalent to the program.”

What is claimed is:

1. An information processing device configured to communicate with a vehicle, the information processing device comprising a controller configured to:
determine a scheduled pickup date and time of a first vehicle to be parked in a parking lot;
determine a scheduled pickup date and time of a second vehicle parked in the parking lot; and
present a space adjacent to the second vehicle in a leaving direction of the second vehicle to the first vehicle as a parkable spot when the scheduled pickup date and time of the first vehicle is earlier than the scheduled pickup date and time of the second vehicle.

2. The information processing device according to claim 1, wherein the controller is configured to move the first vehicle to a location different from the space adjacent to the second vehicle in the leaving direction of the second vehicle at a date and time earlier than the scheduled pickup date and time of the second vehicle, when the scheduled pickup date and time of the second vehicle is changed to a date and time earlier than the scheduled pickup date and time of the first vehicle after the first vehicle is parked in the space adjacent to the second vehicle in the leaving direction of the second vehicle.

3. The information processing device according to claim 1, wherein the controller is configured to present as the parkable spot the space adjacent to the second vehicle in the leaving direction of the second vehicle whose scheduled pickup date and time are least probable to be moved forward out of a plurality of the second vehicles, when the scheduled pickup date and time of the first vehicle is earlier than the scheduled pickup dates and times of the second vehicles.

4. The information processing device according to claim 1, wherein the controller is configured to ask a user of the second vehicle for permission for the first vehicle to be parked in the space adjacent to the second vehicle in the leaving direction of the second vehicle before the controller presents the space adjacent to the second vehicle in the leaving direction of the second vehicle as the parkable spot, when the scheduled pickup date and time of the first vehicle is earlier than the scheduled pickup date and time of the second vehicle.

5. The information processing device according to claim 4, wherein the controller is configured to notify the first vehicle that the controller is asking the user of the second vehicle for the permission.

6. The information processing device according to claim 1, wherein the controller is configured to notify the first vehicle that there is a possibility that the first vehicle is moved to a location different from the space adjacent to the second vehicle in the leaving direction of the second vehicle due to a change in the scheduled pickup date and time of the second vehicle, when the scheduled pickup date and time of the first vehicle is earlier than the scheduled pickup date and time of the second vehicle.

7. The information processing device according to claim 1, wherein the controller is configured to present the space adjacent to the second vehicle in the leaving direction of the second vehicle as the parkable spot when an occupancy rate of the parking lot is higher than a reference value.

8. A vehicle comprising the information processing device according to claim 1.

9. A non-transitory storage medium storing a program that is executable by a computer serving as an information processing device configured to communicate with a vehicle and that causes the computer to perform functions comprising:
determining a scheduled pickup date and time of a first vehicle to be parked in a parking lot;
determining a scheduled pickup date and time of a second vehicle parked in the parking lot; and
presenting a space adjacent to the second vehicle in a leaving direction of the second vehicle to the first vehicle as a parkable spot when the computer determines that the scheduled pickup date and time of the first vehicle is earlier than the scheduled pickup date and time of the second vehicle.

10. The non-transitory storage medium according to claim 9, wherein the functions further comprise moving the first vehicle to a location different from the space adjacent to the second vehicle in the leaving direction of the second vehicle at a date and time earlier than the scheduled pickup date and time of the second vehicle, when the scheduled pickup date and time of the second vehicle is changed to a date and time earlier than the scheduled pickup date and time of the first vehicle after the first vehicle is parked in the space adjacent to the second vehicle in the leaving direction of the second vehicle.

11. The non-transitory storage medium according to claim 9, wherein the functions further comprise presenting as the parkable spot the space adjacent to the second vehicle in the leaving direction of the second vehicle whose scheduled pickup date and time are least probable to be moved forward out of a plurality of the second vehicles, when the scheduled pickup date and time of the first vehicle is earlier than the scheduled pickup dates and times of the second vehicles.

12. The non-transitory storage medium according to claim 9, wherein the functions further comprise asking a user of the second vehicle for permission for the first vehicle to be parked in the space adjacent to the second vehicle in the leaving direction of the second vehicle before presenting the space adjacent to the second vehicle in the leaving direction of the second vehicle as the parkable spot, when the scheduled pickup date and time of the first vehicle is earlier than the scheduled pickup date and time of the second vehicle.

13. The non-transitory storage medium according to claim 12, wherein the functions further comprise notifying the first vehicle that the computer is asking the user of the second vehicle for the permission.

14. The non-transitory storage medium according to claim 9, wherein the functions further comprise notifying the first vehicle that there is a possibility that the first vehicle is moved to a location different from the space adjacent to the second vehicle in the leaving direction of the second vehicle due to a change in the scheduled pickup date and time of the second vehicle, when the scheduled pickup date and time of the first vehicle is earlier than the scheduled pickup date and time of the second vehicle.

15. An information processing method that is performed by an information processing device configured to communicate with a vehicle, the information processing method comprising:
determining a scheduled pickup date and time of a first vehicle to be parked in a parking lot;
determining a scheduled pickup date and time of a second vehicle parked in the parking lot; and
presenting a space adjacent to the second vehicle in a leaving direction of the second vehicle to the first vehicle as a parkable spot when the scheduled pickup date and time of the first vehicle is earlier than the scheduled pickup date and time of the second vehicle.

16. The information processing method according to claim 15, further comprising moving the first vehicle to a location different from the space adjacent to the second vehicle in the leaving direction of the second vehicle at a date and time earlier than the scheduled pickup date and time of the second vehicle, when the scheduled pickup date and time of the second vehicle is changed to a date and time earlier than the scheduled pickup date and time of the first vehicle after the first vehicle is parked in the space adjacent to the second vehicle in the leaving direction of the second vehicle.

17. The information processing method according to claim 15, further comprising presenting as the parkable spot the space adjacent to the second vehicle in the leaving direction of the second vehicle whose scheduled pickup date and time are least probable to be moved forward out of a plurality of the second vehicles, when the scheduled pickup date and time of the first vehicle is earlier than the scheduled pickup dates and times of the second vehicles.

18. The information processing method according to claim 15, further comprising asking a user of the second vehicle for permission for the first vehicle to be parked in the space adjacent to the second vehicle in the leaving direction of the second vehicle before presenting the space adjacent to the second vehicle in the leaving direction of the second vehicle as the parkable spot, when the scheduled pickup date and time of the first vehicle is earlier than the scheduled pickup date and time of the second vehicle.

19. The information processing method according to claim 18, further comprising notifying the first vehicle that the user of the second vehicle is being asked for the permission.

20. The information processing method according to claim 15, further comprising notifying the first vehicle that there is a possibility that the first vehicle is moved to a location different from the space adjacent to the second vehicle in the leaving direction of the second vehicle due to a change in the scheduled pickup date and time of the second vehicle, when the scheduled pickup date and time of the first vehicle is earlier than the scheduled pickup date and time of the second vehicle.
